(19) United States
(12) Patent Application Publication
(10) Pub. No.: US 2026/0177782 A1
(43) Pub. Date: Jun. 25, 2026

(54) LIGHTING DEVICE

(71) Applicant: VALEO VISION, Bobigny (FR)

(72) Inventor: Yves GROMFELD, Bobigny (FR)

(73) Assignee: VALEO VISION, Bobigny (FR)

(21) Appl. No.: 19/127,538

(22) PCT Filed: Oct. 26, 2023
(86) PCT No.: PCT/EP2023/079903

§ 371 Date: May 6, 2025

(30) Foreign Application Priority Data
Nov. 6, 2022 (FR) FR2211529

(51) Int. Cl. G02B 13/00; F21S 41/143; F21S 41/663; F21S 43/14; F21Y 115/10; G02B 13/18

(52) U.S. Cl. CPC G02B 13/004; F21S 41/143; F21S 41/663; F21S 43/14; G02B 13/0045; G02B 13/18; F21Y 2115/10

(57) ABSTRACT

The invention relates to a lighting device including a first row of light sources, an optical axis, a first lens including a first output diopter with a first lower portion having a first curvature and a first upper portion having a second curvature, and a second lens including a second input diopter with a second lower portion having a third curvature and a second upper portion having a fourth curvature. The first curvature is different from the second curvature and is configured to produce a greater spread of the light rays than the spread produced by the second curvature, and/or the third curvature is different from the fourth curvature and is configured to produce a greater spread of the light rays than the spread produced by the fourth curvature.

### TECHNICAL FIELD

The present invention relates to the field of lighting and/or signaling and to the members, notably optical members, involved. It is particularly advantageously applicable to the field of automotive vehicles. Notably, it relates to a lighting device.

### BACKGROUND OF THE INVENTION

In the automotive sector, devices capable of emitting light beams, also referred to as lighting and/or signaling functions, are known.

These devices have to meet the applicable regulations by emitting light at the desired locations while limiting the brightness in certain zones. One of the constraints that manufacturers also face is the reduction of the size of the device, in order to obtain a device that is the most easily usable.

In order to achieve these different objectives, a solution has been proposed in document CN211040826U. This solution is based on the development of a de-vice to increase the illuminated area in front of the vehicle. More specifically, it involves increasing the lighting distance and the lighting width.

Nevertheless, this type of solution has drawbacks, notably the fact that it is limited in terms of zones that can be suitably illuminated.

One subject of the present invention is therefore to propose a device that over-comes the aforementioned drawback.

The other subjects, features and advantages of the present invention will become apparent upon studying the following description and the accompanying drawings. It will be understood that other advantages may be incorporated.

### SUMMARY OF THE INVENTION

To achieve this objective, according to one embodiment, a lighting device is provided comprising:

a first row of light sources comprising light sources aligned in a first direction,

an optical axis, the optical axis and the first direction defining a first plane, a second plane being perpendicular to the first plane and comprising the optical axis,

a first lens comprising a first entry diopter and a first exit diopter comprising a first lower portion having a first curvature in the second plane and a first upper portion having a second curvature in the second plane, the first upper portion and the first lower portion being located on both sides of a third plane, the third plane being parallel to the first plane, the first upper portion being located above the first lower portion, and

a second lens comprising a second exit diopter and a second entry diopter comprising a second lower portion having a third curvature in the second plane and a second upper portion having a fourth curvature in the second plane, the second upper portion and the second lower portion being located on both sides of the third plane, the second upper portion being located above the second lower portion, and

wherein the first lens, the second lens and the first row of light sources are positioned along the optical axis such that light rays from the first row of light sources propagate through the first lens and then through the second lens

characterized in that the first curvature is different from the second curvature and is configured to produce, in the second plane, a greater spread of the light rays than the spread produced by the second curvature, and/or the third curvature is different from the fourth curvature and is configured to produce, in the second plane, a greater spread of the light rays than the spread produced by the fourth curvature.

Thus, since the first curvature is different from the second curvature and/or the third curvature is different from the fourth curvature, the lighting device enables optimized distribution of light, and more precisely in planes orthogonal to the plane containing the optical axis and the first row of light sources. This light distribution makes it possible to precisely define the contour (in particular the lower limit) of the zones illuminated by each luminous element of the source. This ensures good definition of the images projected by the various pixels, and their vertical spread is satisfactory.

According to another aspect, the invention relates to a lighting device in which the first exit diopter comprises a third upper portion positioned above the first upper portion, the third upper portion having a fifth curvature that is more convex than the second curvature.

Thus, the fact that the fifth curvature is more convex than the second curvature provides greater illumination in the upper portion of the illuminated zone, thereby also increasing safety.

The invention also relates to a vehicle equipped with at least one device.

### BRIEF DESCRIPTION OF DRAWINGS

The aims, subjects, features and advantages of the invention will become more clearly apparent from the detailed description of one embodiment of the invention, which is illustrated by the following accompanying drawings, in which:

FIG. 1 is a sectional view of the lighting device in the second plane showing the first row of light sources, the first lens and the second lens.

FIG. 2 is a sectional view of the first lens in the second plane showing the configuration of the first curvature according to the invention.

FIG. 3 is a sectional view of the second lens in the second plane showing the configuration of the third curvature according to the invention.

The drawings are provided by way of example and do not limit the invention. They are schematic conceptual representations intended to facilitate understanding of the invention and are not necessarily drawn to the scale of practical applications.

### DETAILED DESCRIPTION OF THE INVENTION

Before a detailed review of embodiments of the invention, optional features that may possibly be used in combination or alternatively are set out below.

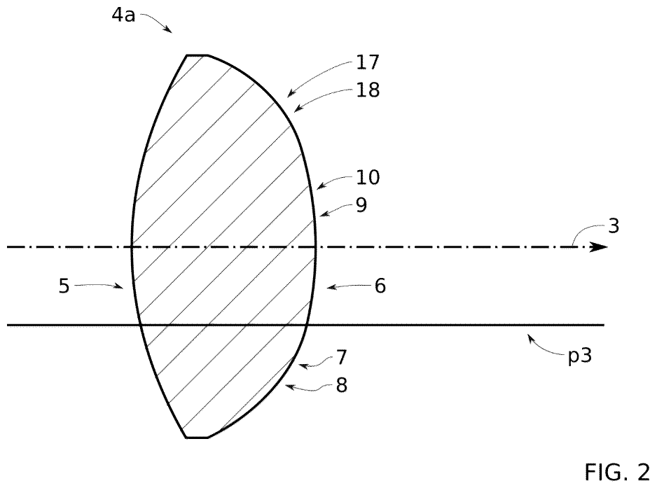

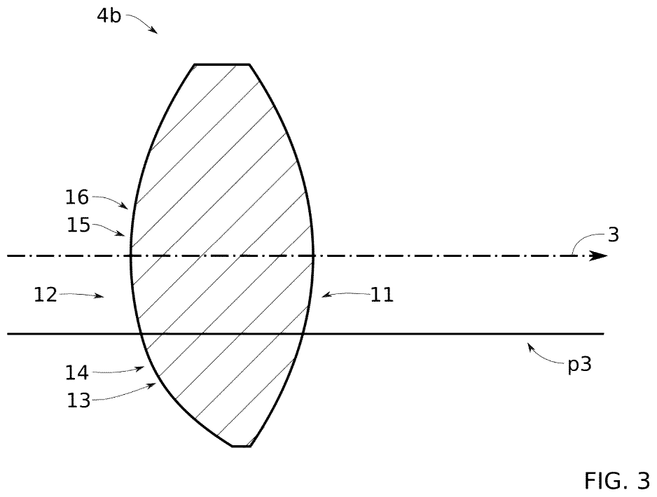

According to one example, as illustrated in FIG. 2 and FIG. 3, the first curvature 8 of the lighting device 1 is more convex than the second curvature 10, and/or the third curvature 14 of the lighting device 1 is more convex than the fourth curvature 16.

This means that the light rays from the first row of light sources 2, after passing through the first lower portion 7, are oriented in a direction more towards the top of the second lens 4b than would be the case if the first curvature 8 had the same concavity as the second curvature 10. These light rays, after passing through the second lens 4b, illuminate a zone located above the optical axis 3 by spreading in height in planes transverse to the plane formed by the optical axis and the first row of light sources 2. Similarly, the light rays, after passing through the second lower portion 13, are oriented in a more upwards direction (compared to the position of the optical axis) than would be the case if the third curvature 14 had the same concavity as the fourth curvature 16.

According to one example, the third plane p3 of the lighting device 1 comprises the optical axis 3.

In this configuration, the third plane p3 is therefore a midplane of the lenses 4a and 4b. This means that the light rays passing through the first lens 4a and the second lens 4b that are above the optical axis 3 and close to the optical axis 3 are deviated by the second curvature 10 and the third curvature 14, whereas they would not be deviated if the first curvature 8 had the same concavity as the second curvature 10 and if the third curvature 14 had the same concavity as the fourth curvature 16.

According to one example, the first row of light sources 2 of the lighting device 1 comprises at least one electroluminescent source with a maximized emissive portion.

Thus, in this way, where several electroluminescent sources are used, the spatial resolution between these different sources is minimal. Indeed, there is minimal space between the different light sources.

According to one example, at least one second row of light sources 19 comprising light sources is positioned in contact with the first row of light sources 2 in a second direction d2 parallel to the first direction d1 so that light rays from the second row of light sources 19 propagate through the first lens 4a.

Implementing several second rows of light sources 20 increases the spatial density of the emitted light rays. The number of light rays will be greater in the zone of interest and more precisely in a zone substantially close to the optical axis, which will result in a greater brightness in this zone.

According to one example, the first row of light sources 2 of the lighting device 1 is positioned at a distance between 0.25 mm and 10 mm from the first lens 4a.

This distance can be measured on the optical axis of the first lens 4a.

This distance is chosen notably in consideration of the thermal resistance of the material of the first lens 4a, which is selected so as to minimize the distance between the rows of light sources and the first lens 4a as much as possible, in order to collect the maximum amount of light and thus maximize efficiency.

According to one example, the lighting device is configured to produce a beam, preferably to participate in a high-beam function, 70% to 90% of the light rays of the beam spreading above the first plane.

According to one example, the light sources of the first row of light sources and of the second row of light sources of the lighting device can be individually activated, and the lighting device comprises control means for selective activation of the light sources of the first row of light sources and the second row of light sources.

Selective activation of the light sources provides varied light beam configurations that can be adapted to various situations.

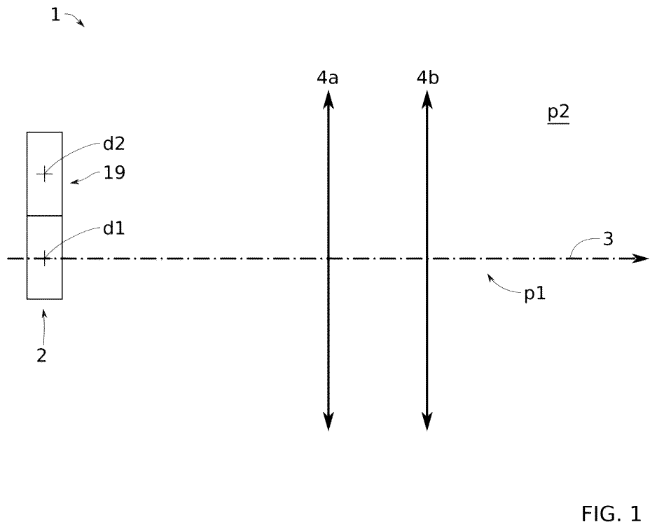

According to one embodiment, as illustrated in FIG. 1, the lighting device 1 comprises a first row of light sources 2, an optical axis 3, a first lens 4a and a second lens 4b. The first lens may form a field lens. The second lens 4b preferably forms a projection lens. Other lenses, in particular downstream of the second lens 4b, may however be used.

The light sources of the first row of light sources 2 are arranged in a straight line in a first direction d1. The optical axis 3 and the first direction d1 form a first plane p1. A second plane p2 is defined to be orthogonal to the first plane p1 and to contain the optical axis 3.

The light sources can be switched on individually, thereby creating a pixelated light source.

The first lens 4a comprises a first entry diopter 5 and a first exit diopter 6. The first exit diopter 6 comprises a first lower portion 7 and a first upper portion 9. Preferably, the first entry diopter 5 and the first exit diopter 6 are convex.

The intersection between the first lower portion 7 and the second plane p2 forms a curved line referred to as the “first curvature 8”. The intersection between the first upper portion 9 and the second plane p2 forms a curved line referred to as the “second curvature 10”. Advantageously, the first curvature 8 and the second curvature 10 define a circular arc.

The first upper portion 9 is positioned above the third plane p3 while the first lower portion 7 is positioned below the third plane p3. The first upper portion 9 and the first lower portion 7 meet at the third plane p3.

The second lens 4b comprises a second exit diopter 11 and a second entry diopter 12. The second entry diopter 12 comprises a second lower portion 13 and a second upper portion 15. The intersection between the second lower portion 13 and the second plane p2 forms a curved line referred to as the “third curvature 14”. The intersection between the second upper portion 15 and the second plane p2 forms a curved line referred to as the “fourth curvature 16”. Advantageously, the second exit diopter 11 and the second entry diopter 12 are convex. Preferably, the first curvature 8 and the second curvature 10 define a circular arc. The second upper portion 15 is positioned above the third plane p3 while the second lower portion 13 is positioned below the third plane p3. The second upper portion 15 and the second lower portion 13 meet at the third plane p3.

The first lens 4a, the second lens 4b and the first row of light sources 2 are distributed on the optical axis 3 so that light rays from the first row of light sources 2 pass through the first lens 4a first and through the second lens 4b second. This means that the first row of light sources 2, the first lens 4a and the second lens 4b are positioned successively on the optical axis 3.

The first curvature 8 differs from the second curvature 10 and is configured to pro-duce, in the second plane p2, a staggering of the light rays so that the aver-age distance between any two light rays is greater than the average distance between any two light rays produced by the second curvature 10. Additionally or alternatively, the third curvature 14 differs from the fourth curvature 16. The third curvature 14 is configured to produce, in the second plane p2, a staggering of the light rays so that the average distance between any two light rays is greater than the average distance between any two light rays produced by the fourth curvature 16.

Preferably, the first curvature 8 is more convex than the second curvature 10. Advantageously, where the first curvature 8 and the second curvature 10 define a circular arc, the first curvature 8 has a radius at least 33% smaller than the radius of the second curvature 10.

Additionally or alternatively, the third curvature 14 is more re-entrant than the fourth curvature 16. According to a preferred embodiment, where the third curvature 14 and the fourth curvature 16 define a circular arc, the third curvature 14 has a radius at least 30% smaller than the radius of the fourth curvature 16.

According to a preferred embodiment, the third plane p3 passes through the optical axis 3.

Advantageously, the first exit diopter 6 comprises a third upper portion 17 positioned above the first upper portion 9. The third upper portion 17 has a fifth curvature 18 that is more re-entrant than the second curvature 10. According to a preferred embodiment, where the fifth curvature 18 and the second curvature 10 define a circular arc, the fifth curvature 18 has a radius at least 30% smaller than the radius of the second curvature 10.

This means that the light rays passing through the fifth curvature 18 are more oriented towards the top of the second lens 4b than if the fifth curvature 18 were identical to the second curvature 10. After passing through the second lens 4b, the light rays continue their path while keeping substantially the same upward orientation, which results in a higher density of light rays in the targeted zone, thus resulting in a higher luminous intensity.

Preferably, the second lens 4b is made of PMMA 121. The system comprising the first lens 4a and the second lens 4b may have a focal length of 45.7 mm. Advantageously, the second lens 4b has a size of 40 by 70 mm. The geometrical aperture of the system comprising the first lens 4a and the second lens 4b is 0.55. Preferably, the first lens 4a has a thickness of between 2 mm and 30 mm. The second lens 4b has a thickness of between 2 mm and 30 mm. In a preferred option, the first row of light sources 2 comprises at least one electro-luminescent source with a maximized emissive portion. A maximized emissive portion may be an emissive portion exposed to the surface of the source, in the sense that it is not coated with any optically active portion (notably no lenses or filters) or photonically active portion (notably no light re-emitting layers, for example by luminescence, notably by luminescent particles).

These sources may notably comprise at least one semiconductor chip able to emit light. Moreover, “light source” is here understood to mean a set of at least one elementary source able to produce a flux that causes at least one light beam to be output from the device of the invention.

Thus, this type of light source is used so that these sources can be arranged very close to one another (typically with a gap of less than 50 microns, or even less than 25 microns). Images can be formed directly from these sources. However, the efficiency of the optical device is maintained and the pixels are shaped, notably vertically, by the primary optical element, which is an element common to the sources.

The source may be laterally delimited by several circumferential walls, which ex-tend along the growth axis of the diode, and by an end face. The end face, in this case, comprises an emissive portion through which light is emitted when the diode is biased.

The emissive portion may be either a layer, which may be referred to as an active layer, in which photon generation is carried out by electron-hole recombinations, or, more commonly, especially for white light, a conversion layer with charges, such as phosphor particles, allowing photons produced in the active layer to be re-emitted in a wavelength band adapted to the application.

The light source according to the invention can be provided with a maximized emissive portion. In fact, the emissive portion is exposed to the end face of the source and occupies at least 90% of the surface of said end face, preferably 98% and even more preferably 100% of the surface. In the latter case, the emissive portion then forms the exit face of the light from the source.

In one advantageous embodiment, the end face of the source is of rectangular cross section, this being typical for LED chips. Thus, the emissive portion also has a rectangular cross section which is slightly smaller than that of the exit face. Notably, the length of one of the sides of the emissive portion is less than the length of one of the sides of the source end face by a value between 10 micrometers and 40 micrometers. In other words, the distance between an edge of the end face and an edge of the emissive portion can be between 5 micrometers and 20 micrometers.

In the case of individually packaged light-emitting sources, also referred to as LED chips, the maximized size of the emissive portion results in a reduction in the size of the housing surrounding the light-emitting diode. Indeed, the housing may comprise edges which cover the circumferential walls of the diode. By having the emissive portion occupy almost all or all of the end face of the diode, these edges can be configured to have a very small thickness, for example of the order of a few micrometers. Thus, the housing surrounding the light-emitting diode is almost the same size as said diode. The housing is only a few micrometers larger than the end face of the diode.

Notably, sources sold under the brand name Luxeon NEO Exact® by Lumileds® can be used.

Another example of light sources with a maximized emissive portion are light sources comprising at least two rows of sources on a common substrate. This arrangement of elements may result from growth on the substrate from which said elements were respectively grown, or from any other production method, for example transfer of the elements using transfer techniques. Various arrangements of electroluminescent elements may meet this definition of a monolithic array, provided that the electroluminescent elements have one of their main dimensions of elongation substantially perpendicular to a common substrate and that the transverse spacing between the pixels, formed by one or more electroluminescent elements grouped together electrically, is small in comparison with the spacings that are imposed in known arrangements of generally flat square chips soldered to a printed circuit board.

In other words, in the invention, it may be a monolithic electroluminescent source that is divided into several individual segments. The individual segments are separated by a thin wall, for example made of silicone. The thickness of this thin wall is between 10 micrometers and 25 micrometers. Notably, sources sold under the brand name PixCell® by Samsung® can be used.

Preferably, at least one second row of light sources 19 is aligned with the first row of light sources 2 in a second direction d2. The second direction d2 is parallel to the first direction d1. The second row of light sources 19 is positioned relative to the first row of light sources 2 so that light rays from the second row of light sources 19 propagate through the first lens 4a.

The first row of light sources 2 may be spaced apart from the second row of light sources 19 by a distance equal to 1.025 mm if the LEDs have an emissive sur-face area of 1mm2.

Preferably, the first row of light sources 2 and the second row of light sources 19 are made up of 24 light sources.

Advantageously, the LEDs have an emissive surface area of 1mm2.

According to one option, the first row of light sources 2 is located at a distance between 0.25 mm and 10 mm from the first lens 4a. The distance between the first row of light sources 2 and the first lens 4a may be 2.2 mm.

The rows of light sources may be positioned perpendicularly to the optical axis of the first lens 4a. The rows of light sources may be positioned symmetrically with respect to the optical axis so that there is an equal number of light sources on each side of the optical axis.

A lighting device 1 of the invention may be fitted to a vehicle, and, preferably, said vehicle is also equipped with at least one other device for projecting at least one other beam. This means that several lighting devices 1 may be arranged in a housing closed by an outer lens so as to obtain one or more lighting and/or signaling beams at the output of the headlamp. A headlamp may also be complex and combine a plurality of devices that may, furthermore, optionally share components.

Advantageously, a lighting device 1 of the invention may be fitted to headlamps of a vehicle and in particular to a front headlamp of a vehicle or to two front headlamps of a vehicle where one headlamp is positioned to the right and another is positioned to the left.

Preferably, the lighting device 1 is configured to form a beam, preferably to participate in forming a high beam. Between 70% and 90% of the light rays of the beam thus formed are located above the first plane p1. The first plane pl can correspond to a projection along a horizon line.

The invention may contribute to a high-beam function, the function of which is to provide illumination over a wide area in front of the vehicle, and also over a substantial distance, typically about two hundred meters. This light beam, due to its lighting function, is mainly located above the horizon line. It may for example have a slightly upward sloping lighting optical axis. Notably, it may be used to generate a “complementary” lighting function that forms a portion of a high beam complementary to the portion produced by a near-field beam, the complementary high-beam portion being entirely, or at least mainly, intended to illuminate above the horizon line, whereas the near-field beam (which may have the specific features of a low beam) is intended to illuminate entirely, or at least mainly, below the horizon line. The complementary high-beam portion may therefore be a main part of the overall “high” beam and be associated with another beam participating in the low beam.

The device may also be used for other lighting functions via or apart from those described above in relation to adaptive beams. This makes it possible to produce a lighting matrix to selectively illuminate parts of the space in front of the vehicle.

Preferably, the light sources of the first row of light sources 2 and of the second row of light sources 19 of the lighting device 1 can be switched on individually. The lighting device 1 comprises control means enabling the individual selection of the light sources of the first row of light sources 2 and the second row of light sources 19 to be switched on.

It will be noted that each row of sources can be controlled so as to activate them selectively. This means that all the emissive elements are not necessarily active, i.e. emitting light, simultaneously. This function allows the shape of the generated beam to be modulated. If a light source is not activated, its image, as projected by the optical device, will be null. It then forms a lighting void in the resulting overall beam. This void is interrupted only by source-coupling effects and the effects of stray light from the optics.

The sources are preferably part of a light generation system which preferably comprises a support, one face of which carries selectively activatable sources, based on the technology of semiconductor emissive elements, including the light-emitting diodes (LEDs), as detailed below.

The system according to the invention may comprise a unit for driving the activation of each of the sources that is configured to produce at least one dark zone forming a tunnel in a projected beam by deactivating a group of adjacent sources, the driving unit being configured to determine the number of sources of the group corresponding to the dark zone as a function of the width of the sources.

The driving unit may comprise a computer program product, preferably stored in a non-transitory memory, the computer program product comprising instructions that, when executed by a processor, determine the sources to be activated, in particular to obtain at least one dark zone (in which the sources are not activated) of defined area, taking into account the variable surface area of the images of the elements.

The conventional sources currently used in the automotive field are light-emitting diodes, also commonly referred to as LEDs, individually encapsulated in a housing. The light-emitting portion of the diode is covered by at least one light-transmissive layer, for example made of transparent polymer material. Depending on the shape of the transmissive layer, it can be used as the primary optics as soon as light is generated in the diode. Thus, such an LED forms a complex assembly combining an emissive portion and an optical portion. Moreover, when these LEDs are arranged next to each other, the emissive portions of the adjacent LEDs are relatively far from each other, which requires optical projection designed to form images that exclude this spacing between the LEDs.

### List of References

Lighting device (1)
First row of light sources (2)
First direction (d1)
Optical axis (3)
First plane (p1)
Second plane (p2)
First lens (4a)
Second lens (4b)
First entry diopter (5)
First exit diopter (6)
First lower portion (7)
First curvature (8)
First upper portion (9)
Second curvature (10)
Second exit diopter (11)
Second entry diopter (12)
Second lower portion (13)
Third curvature (14)
Second upper portion (15)
Fourth curvature (16)
Third upper portion (17)
Fifth curvature (18)
Second row of light sources (19)
Second direction (d2)

What is claimed is:

1. A lighting device comprising:
a first row of light sources including light sources aligned in a first direction,
an optical axis, the optical axis and the first direction defining a first plane, a second plane being perpendicular to the first plane and includes the optical axis,
a first lens including a first entry diopter and a first exit diopter includes a first lower portion having a first curvature in the second plane and a first upper portion having a second curvature in the second plane, the first upper portion and the first lower portion being located on both sides of a third plane, the third plane being parallel to the first plane, the first upper portion being located above the first lower portion, and
a second lens including a second exit diopter and a second entry diopter includes a second lower portion having a third curvature in the second plane and a second upper portion having a fourth curvature in the second plane, the second upper portion and the second lower portion being located on both sides of the third plane, the second upper portion being located above the second lower portion, and
wherein the first lens, the second lens and the first row of light sources are positioned along the optical axis such that light rays from the first row of light sources propagate through the first lens and then through the second lens, and
wherein the first curvature is different from the second curvature and is configured to produce, in the second plane, a greater spread of the light rays than the spread produced by the second curvature, and/or the third curvature is different from the fourth curvature and is configured to produce, in the second plane, a greater spread of the light rays than the spread produced by the fourth curvature.

2. The lighting device as claimed in claim 1, wherein the first curvature is more convex than the second curvature, and/or the third curvature is more convex than the fourth curvature.

3. The lighting device as claimed in claim 1, wherein the third plane includes the optical axis.

4. The lighting device as claimed in claim 1, wherein the first exit diopter includes a third upper portion positioned above the first upper portion, the third upper portion having a fifth curvature that is more convex than the second curvature.

5. The lighting device as claimed in claim 1, wherein the first row of light sources includes at least one electroluminescent source with a maximized emissive portion.

6. The lighting device as claimed in claim 1, wherein at least one second row of light sources including light sources is positioned in contact with the first row of light sources in a second direction parallel to the first direction so that light rays from the second row of light sources propagate through the first lens.

7. The lighting device as claimed in claim 6, wherein the light sources of the first row of light sources and of the second row of light sources can be individually activated, and further comprising control means for selective activation of the light sources of the first row of light sources and the second row of light sources.

8. The lighting device as claimed in claim 1, wherein the first row of light sources is positioned at a distance between 0.25 mm and 10 mm from the first lens.

9. The lighting device as claimed in claim 1 configured to produce a beam, preferably to participate in a high-beam function, 70% to 90% of the light rays of the beam spreading above the first plane.
